(19) United States
(12) Patent Application Publication
(10) Pub. No.: US 2023/0146872 A1
(43) Pub. Date: May 11, 2023

(54) ELECTRIC CONNECTION BOX

(71) Applicants: Sumitomo Wiring Systems, Ltd., Yokkaichi (JP); TOYOTA JIDOSHA KABUSHIKI KAISHA, Toyota-shi (JP)

(72) Inventors: Takayuki TAKEUCHI, Yokkaichi (JP); Yoshiki Yanagita, Nagakute-shi (JP); Shogo Tomihira, Nisshin-shi (JP)

(21) Appl. No.: 18/054,649

(22) Filed: Nov. 11, 2022

(30) Foreign Application Priority Data
Nov. 11, 2021 (JP) 2021-184098

(51) Int. Cl. B60R 16/023; H02G 3/08; H01M 50/262; H01M 10/42

(52) U.S. Cl. CPC B60R 16/0238; H02G 3/08; B60R 16/0239; H01M 50/262; H01M 10/425

(57) ABSTRACT

Provided is an electric connection box that can be removed with ease and safety. The electric connection box has a housing where an electronic component is mounted. Adhering portions adhering to an object is provided on an outside surface of a bottom plate of the housing. The adhering portions have reduction portions reduced in area toward at least one end portion of the housing.

### CROSS-REFERENCE TO RELATED APPLICATION

This application claims priority of Japanese Patent Application No. 2021-184098 filed on Nov. 11, 2021, the entire contents of which are incorporated herein.

### TECHNICAL FIELD

The present disclosure relates to an electric connection box.

### BACKGROUND

In the related art, a vehicle is equipped with an electric connection box where an electronic component such as a relay is mounted.

For example, Japanese Patent Application Laid-Open No. 2021-151054 discloses an electric connection box accommodated in, for example, an electric vehicle (EV) battery pack together with battery cells.

An electric connection box may be attached to a battery pack and share a cooling mechanism with the battery pack.

In this case, the electric connection box is attached to the cooling mechanism of the battery pack using an adhesive for an increase in contact area and an increase in thermal conductivity, and a filler is interposed in the space between the electric connection box and the cooling mechanism of the battery pack.

By the way, it may be necessary to replace the electric connection box for some reason. The electric connection box needs to be removed from the cooling mechanism of the battery pack in order to be replaced. However, in many cases, the adhesive hardens over time to make it difficult to remove the electric connection box. At this time, forcibly pulling the electric connection box may result in deformation of or damage to the electric connection box itself.

However, in the electric connection box of Japanese Patent Application Laid-Open Publication No. 2021-151054, electric connection box replacement is not assumed, and thus the above problems cannot be solved with nothing devised as to safe electric connection box removal.

### SUMMARY

The present disclosure has been made in view of such circumstances, and an object of the present disclosure is to provide an electric connection box that can be removed with ease and safety.

An electric connection box according to an embodiment of the present disclosure has a housing where an electronic component is mounted. An adhering portion adhering to an object is provided on an outside surface of the housing. The adhering portion has a reduction portion reduced in area toward at least one end portion of the housing.

According to the present disclosure, the electric connection box can be removed with ease and safety.

The above and further objects and features will more fully be apparent from the following detailed description with accompanying drawings.

### BRIEF DESCRIPTION OF THE DRAWINGS

FIG. 1 is a perspective view of an electric connection box according to Embodiment 1;

FIG. 2 is a bottom view of the electric connection box according to Embodiment 1;

FIG. 3 is a diagram illustrating a state where a lower case is removed from the electric connection box;

FIG. 4 is a partial plan view of an upper case of the electric connection box;

FIG. 5 is a perspective view illustrating the lower case of the electric connection box; and

FIG. 6 is a bottom view of an electric connection box according to Embodiment 2.

### DETAILED DESCRIPTION OF PREFERRED EMBODIMENTS

First, an aspect of implementation of the present disclosure will be listed and described. In addition, at least a part of the embodiment described below may be combined in any manner.

### First Aspect

An electric connection box according to a first aspect of the present disclosure has a housing where an electronic component is mounted. An adhering portion adhering to an object is provided on an outside surface of the housing, and the adhering portion has a reduction portion reduced in area toward at least one end portion of the housing.

In the first aspect, the adhering portion is provided with the reduction portion reduced in area toward one end portion of the housing. Accordingly, in a case where a worker removes the housing from the object by pulling one end portion of the housing, the part of the reduction portion with the smallest adhesion area is removed preferentially and easily, and thus the housing is easily removed.

### Second Aspect

In the electric connection box according to a second aspect of the present disclosure, at least the one end portion of the housing is provided with a handle, and a reduced end of the reduction portion is provided so as to face the handle.

In the second aspect, the reduced end of the reduction portion is provided so as to face the handle. Accordingly, in a case where a worker removes the housing from the object by pulling the handle, the reduced end of the reduction portion with the smallest adhesion area is removed preferentially and easily, and thus the housing is easily removed.

### Third Aspect

In the electric connection box according to a third aspect of the present disclosure, the housing includes a box-shaped member having the outside surface as a bottom surface and having an open surface facing the bottom surface, and the handle is provided on the box-shaped member.

In the third aspect, the handle is provided on the box-shaped member.

Accordingly, the pulling force in removing the housing is directly transmitted to the adhering portion to facilitate the removal of the housing.

### Fourth Aspect

In the electric connection box according to a fourth of the present disclosure, the box-shaped member has a recess in a long-side middle portion, and a side wall related to the recess is provided with a plurality of ribs.

In the fourth aspect, the recess formed in the long-side middle portion of the box-shaped member is provided with the plurality of ribs. Accordingly, it is possible to prevent stress concentration from occurring in the recess to cause damage or deformation in a case where the box-shaped member is bent by the pulling force in removing the housing.

### Fifth Aspect

In the electric connection box according to a fifth aspect of the present disclosure, the handle is provided on each of both end portions of the box-shaped member, the adhering portion is provided on each of both end portions of the bottom surface, and a reduced end of each adhering portion faces a nearest handle.

In the fifth aspect, the reduced ends of the adhering portions respectively provided on both end portions of the bottom surface face the handles on the nearest end portions, respectively. Accordingly, in a case where a worker removes the housing by pulling one or both of the handles, the reduced end with the smallest adhesion area in each reduction portion is removed preferentially and easily, and thus the housing is easily removed.

Electric connection boxes according to aspects of the present disclosure will be described below with reference to the drawings. It should be noted that the present disclosure is not limited to the exemplifications. The present disclosure is defined by the scope of the claims and is intended to include every modification within the meaning and scope equivalent to the scope of the claims.

Hereinafter, the present embodiments will be described by taking as an example an electronic component-mounted vehicular electric connection box.

### Embodiment 1

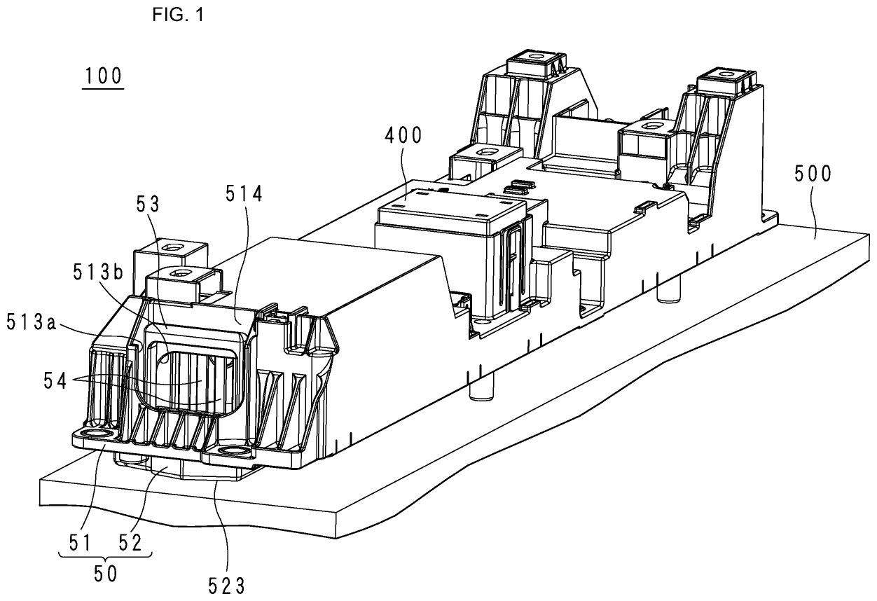

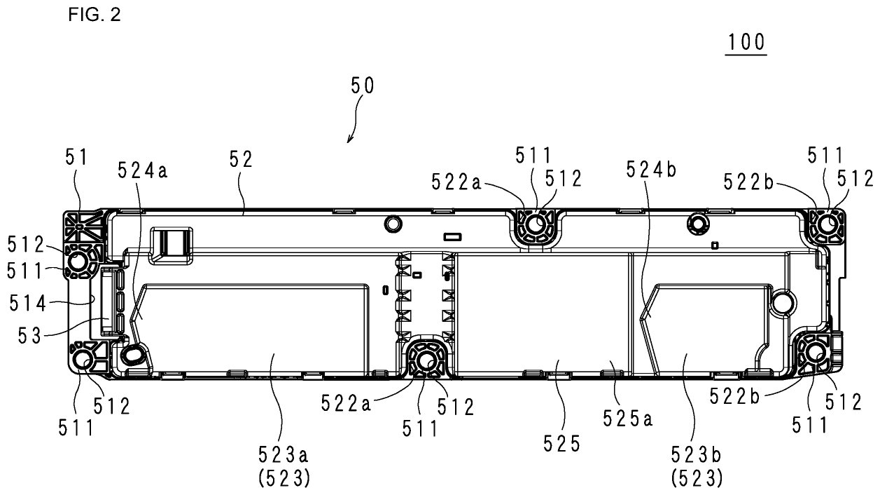

FIG. 1 is a perspective view of an electric connection box 100 according to Embodiment 1, and FIG. 2 is a bottom view of the electric connection box 100 according to Embodiment 1.

The electric connection box 100 is attached to the outside of, for example, an electric vehicle (EV) battery pack 500. The electric connection box 100 includes a housing 50 where an electronic component such as a fuse and a relay 400 is mounted.

Hereinafter, for convenience of description, the battery pack 500 side with respect to the electric connection box 100 will be referred to as the lower side and the electric connection box 100 side with respect to the battery pack 500 will be referred to as the upper side.

The housing 50 is made of, for example, resin or metal and extends in one direction (hereinafter, referred to as length direction). The housing 50 includes a lower case 52 (box-shaped member) close to the battery pack 500 and an upper case 51 covering the lower case 52. The housing 50 is attached to the battery pack 500 with, for example, a bottom plate 525 of the lower case 52 in contact with the battery pack 500.

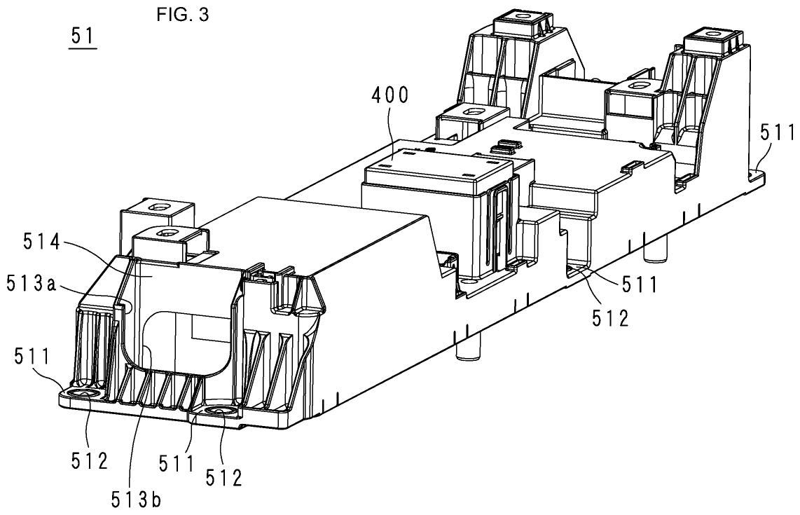

FIG. 3 is a diagram illustrating a state where the lower case 52 is removed from the electric connection box 100. The upper case 51 is a box body extending in the length direction with one open surface on the lower case 52 side. The dimensions of the upper case 51 in the length and width directions are larger than those of the lower case 52, and the upper case 51 covers the lower case 52.

In addition, the upper case 51 is provided with leg portions 511 for attachment to the battery pack 500 in both end portions and the middle portion in the length direction. Specifically, two leg portions 511 are provided near each of both short sides of the upper case 51, and the leg portions 511 are also provided in the respective middle portions of both long sides of the upper case 51. The leg portions 511 provided in both end portions of the upper case 51 have flat plate-shaped flange portions, and fixing through holes 512 are formed in such flange portions. In addition, as for the leg portion 511 provided in the middle portion of the upper case 51, the fixing through hole 512 is formed in a flat plate-shaped flange portion that is formed by notching in a rectangular shape in a plan view. For example, the housing 50 (electric connection box 100) can be attached to the battery pack 500 by inserting a screw through the fixing through hole 512 in the leg portion 511 and performing screwing into a screw hole (not illustrated) provided in the battery pack 500.

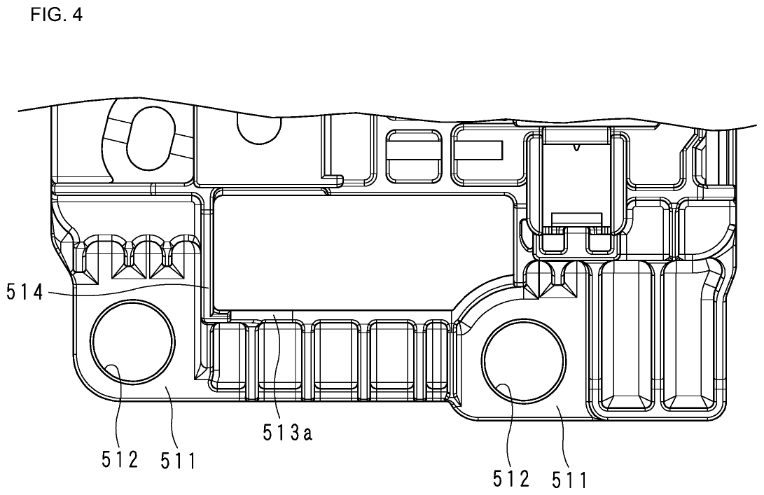

FIG. 4 is a partial plan view of the upper case 51 of the electric connection box 100. FIG. 4 illustrates a square tube portion 514 of the upper case 51 and the surroundings of the square tube portion 514 in an enlarged manner.

The upper case 51 is provided with the square tube portion 514 in one end portion. As for the square tube portion 514, a rectangular through passage is configured inside in a plan view. As for such a through passage, the dimension in the width direction of the electric connection box 100 is larger than the dimension in the length direction of the electric connection box 100. The upper side of the square tube portion 514 is open to the outside of the electric connection box 100, and the lower side of the square tube portion 514 is open to the inside of the electric connection box 100. In addition, the upper side of the square tube portion 514 is open obliquely with respect to the up-down direction.

As illustrated in FIG. 3, notches 513a and 513b are respectively formed in the two side walls facing each other in the length direction among the side walls related to the square tube portion 514. Of the two side walls, the side wall that is outside in the length direction (hereinafter, referred to as outside wall) is formed with the notch 513a and the side wall that is relatively inside (hereinafter, referred to as inside wall) is formed with the notch 513b.

The notch 513a is formed by notching the outside wall in a substantially rectangular shape downward from the upper end. The notch 513b is formed by notching the inside wall in a substantially rectangular shape upward from the lower end. The dimensions of the notches 513a and 513b in the width direction are substantially equal. The notches 513a and 513b are partially aligned in the length direction. Accordingly, the inside and outside of the upper case 51 (electric connection box 100) communicate with each other through the notches 513a and 513b.

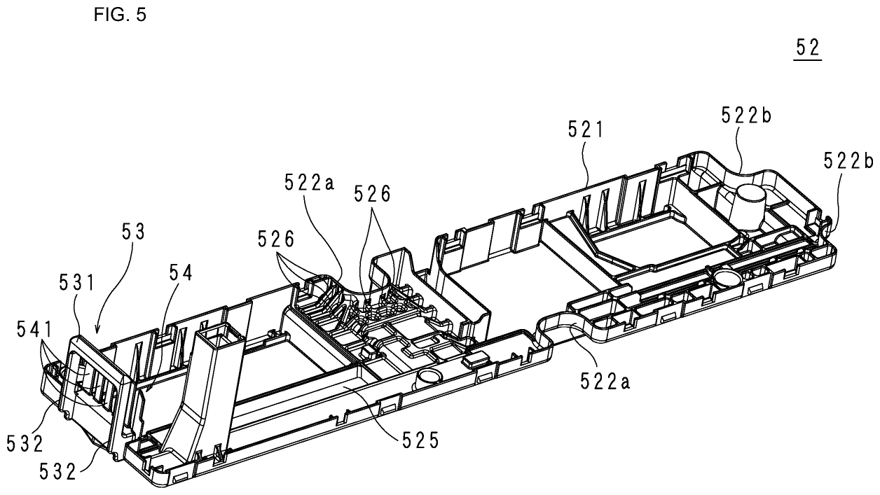

FIG. 5 is a perspective view illustrating the lower case 52 of the electric connection box 100.

The lower case 52 is a box body extending in the length direction with one open surface on the upper case 51 side. The lower case 52 has the elongated and substantially rectangular bottom plate 525 and a side wall 521 provided around the edge of the bottom plate 525. A plurality of ribs are formed and a plurality of pedestals are formed inside the lower case 52. A bus bar, an electronic component (not illustrated), and so on are attached to the pedestal.

A handle 53 and a filter 54 are provided in one end portion of the lower case 52. A recess 522b is formed in the other end portion of the lower case 52. A recess 522a is formed in the middle portion of the lower case 52. The handle 53 and the filter 54 are provided at positions corresponding to the square tube portion 514 of the upper case 51. The recess 522a and the recess 522b are formed at positions corresponding to the leg portion 511 of the upper case 51.

The handle 53 is provided on the side wall 521 that is on the side of the short side of the lower case 52. The handle 53 has an inverted U shape, extends in the up-down direction, and has a pair of support rods 532 provided at a predetermined interval in the width direction and a grip rod 531 provided so as to bridge between the support rods 532. The support rod 532 is larger in up-down-direction dimension than the notch 513b. In the width direction, the interval between the support rods 532 is substantially equal to the dimensions of the notches 513a and 513b (see FIG. 1). For example, the grip rod 531 and the pair of support rods 532 are integrally formed.

The filter 54 is provided inside the handle 53 in the length direction. The filter 54 includes a plurality of substantially strip-shaped standing plates 541. The plurality of standing plates 541 are arranged side by side and at regular intervals in the width direction, and the length direction is the thickness direction thereof.

The recesses 522b are respectively formed at both corners of the other end portion of the lower case 52. The recess 522b is substantially rectangular in a plan view. The side wall 521 is bent at a substantially right angle at the recess 522b, and the recessed corner is chamfered (see FIGS. 2 and 5).

In addition, the recesses 522a are respectively formed in the side wall 521 in the intermediate portions of both long sides of the lower case 52. Both recesses 522a have the same shape and are substantially rectangular in a plan view. The side wall 521 is recessed to the inside of the lower case 52 at the recess 522a, and the recessed corner is chamfered (see FIGS. 2 and 5).

The side wall 521 that configures the recess 522a is provided with a rib 526. In other words, the rib 526 is provided along the inside surface of the side wall 521 related to the recess 522a. The rib 526 is provided from the inside surface of the side wall 521 to the bottom plate 525.

Although FIG. 5 exemplifies a case where only one of both recesses 522a is provided with the rib 526, the present disclosure is not limited thereto. The rib 526 may be provided at each recess 522a.

In assembling the upper case 51 and the lower case 52, the handle 53 of the lower case 52 is inserted into the square tube portion 514 of the upper case 51 and moved through the through passage of the square tube portion 514. When the assembly of the upper case 51 and the lower case 52 is completed, the handle 53 is disposed in the square tube portion 514 of the upper case 51. At this time, the inside wall of the square tube portion 514 is interposed between the handle 53 and the filter 54 of the lower case 52 (see FIG. 1). In other words, the filter 54 is disposed on the back side of the notch 513b of the square tube portion 514.

In addition, the leg portion 511 provided in the middle portion of the upper case 51 is disposed inside the recess 522a, and the leg portion 511 provided in the other end portion of the upper case 51 is disposed inside the recess 522b (see FIG. 2).

As illustrated in FIG. 2, adhering portions 523 are formed on an outside surface 525a of the bottom plate 525 of the lower case 52. The adhering portion 523 is a flat part that adheres to the battery pack 500 when the housing 50 (electric connection box 100) is attached to the battery pack 500, and the part protrudes slightly downward, that is, to the battery pack 500 side as compared with the other part of the outside surface 525a. The adhering portions 523 are formed on both end portions of the outside surface 525a. The adhering portion 523 includes an adhering portion 523a provided in one end portion on the handle 53 side and an adhering portion 523b provided in the other end portion.

The battery pack 500 is provided with a cooling mechanism for cooling the battery cells of the battery pack 500, and the electric connection box 100 attached to the battery pack 500 shares such a cooling mechanism. Accordingly, for an increase in thermal conductivity, adhesion to the battery pack 500 (cooling mechanism) is performed with an adhesive applied to the adhering portion 523 of the electric connection box 100 and a filler is interposed in the space between the electric connection box 100 and the battery pack 500.

Both the adhering portion 523a and the adhering portion 523b have a substantially rectangular shape extending in the length direction of the outside surface 525a (electric connection box 100). The length of the adhering portion 523a exceeds the length of the adhering portion 523b, and the adhering portion 523a and the adhering portion 523b have the same width.

A reduction portion 524a and a reduction portion 524b are formed in the adhering portion 523a and the adhering portion 523b, respectively. In the adhering portion 523a and 523b, the reduction portion 524a and 524b is formed in the short side portion that is one of both short sides in the length direction and close to the handle 53. The reduction portion 524a and 524b is triangular with a vertex facing the handle 53. In other words, the reduction portion 524a and the reduction portion 524b are reduced in area toward the handle 53 and the reduced ends of the reduction portion 524a and the reduction portion 524b face the handle 53.

In other words, each of the reduction portion 524a in the adhering portion 523a and the reduction portion 524b in the adhering portion 523b is reduced in area, as compared to the other part, toward the handle 53. In other words, the reduction portion 524a and the reduction portion 524b taper toward the handle 53.

By the way, it may be necessary to replace the electric connection box 100 for some reason. The electric connection box 100 needs to be removed from the cooling mechanism of the battery pack 500 in order to be replaced. However, in many cases, the adhesive hardens over time to make it difficult to remove the electric connection box 100. At this time, forcibly pulling the electric connection box 100 may result in deformation of or damage to the electric connection box 100 itself.

The electric connection box 100 of Embodiment 1 configured as described above can be easily and safely removed from the battery pack 500, which will be described in detail below.

In removing the electric connection box 100 of the present embodiment, a worker pulls the electric connection box 100 away from the battery pack 500 with the grip rod 531 of the handle 53 gripped.

Meanwhile, as described above, the area of the reduction portion 524a is reduced toward the handle 53, and thus the part that is closest to the handle 53 in the adhering portion 523a is smallest in area of contact with the battery pack 500 (cooling mechanism) in the adhering portion 523a and is easy to remove. Accordingly, it is easy to start removing the adhering portion 523a. Further, even after the removal initiation, the situation in which the part closest to the handle 53 in the reduction portion 524a that has adhered to the battery pack 500 is smallest in area of contact with the battery pack 500 (cooling mechanism) in the adhering portion 523a continues for a while. The adhering portion 523a can be easily removed from the cooling mechanism of the battery pack 500.

In addition, the area of the reduction portion 524b is also reduced toward the handle 53. Accordingly, also in the adhering portion 523b, the part that is closest to the handle 53 is smallest in area of contact with the battery pack 500 (cooling mechanism) in the adhering portion 523b and is easy to remove. As a result, it is easy to start removing the adhering portion 523b. Accordingly, the adhering portion 523b can be easily removed from the cooling mechanism of the battery pack 500.

Accordingly, the electric connection box 100 of Embodiment 1 can be easily and safely removed from the battery pack 500 without deformation or damage.

In addition, in a case where a worker pulls the electric connection box 100 using the handle 53 and, for example, half of the electric connection box 100 (lower case 52) in the length direction is removed from the battery pack 500, the remaining half is still attached to the battery pack 500. At this time, the electric connection box 100 is bent, and thus stress concentrates occurs in the middle portion of the electric connection box 100, particularly the recess 522a reduced in dimension in the width direction.

However, in the electric connection box 100 of Embodiment 1, the rib 526 is provided along the inside surface of the side wall 521 related to the recess 522a as described above, and deformation or damage attributable to the stress concentration can be prevented.

As described above, in the electric connection box 100 of Embodiment 1, the inside and outside of the electric connection box 100 communicate with each other through the notches 513a and 513b. Accordingly, in a case where heat is generated from an electronic component accommodated in the electric connection box 100 during operation, the heat is discharged to the outside without staying in the electric connection box 100.

Further, in the electric connection box 100 of Embodiment 1, the filter 54 is disposed on the back side of the notch 513b of the square tube portion 514 as described above. Accordingly, dust can be prevented from entering the electric connection box 100 through the notches 513a and 513b.

In addition, as described above, in the handle 53 in the electric connection box 100 of Embodiment 1, the support rod 532 is larger in up-down-direction dimension than the notch 513b and the interval between the support rods 532 in the width direction is substantially equal to the dimensions of the notches 513a and 513b. Accordingly, the position of the handle 53 does not overlap the position of the notch 513b in the length direction and the heat in the electric connection box 100 is discharged via the notch 513b without hindrance.

### Embodiment 2

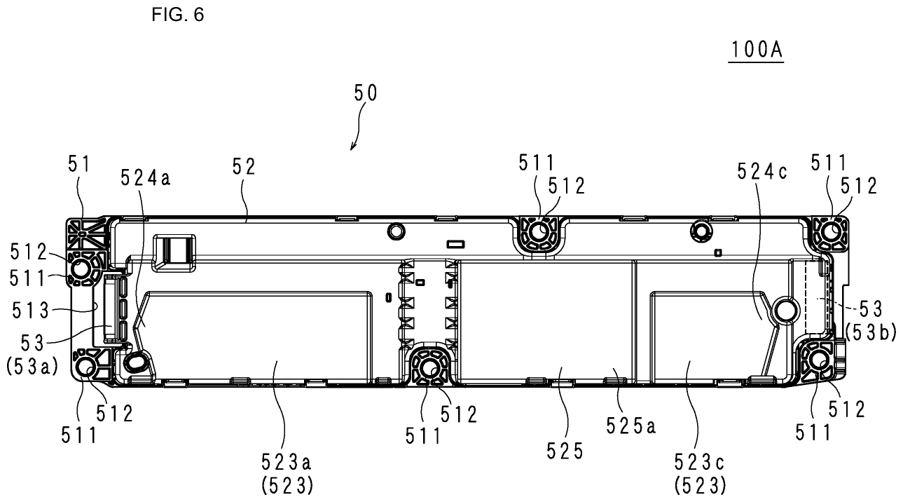

FIG. 6 is a bottom view of an electric connection box 100A according to Embodiment 2. In the electric connection box 100A according to Embodiment 2, the lower case 52 has the handles 53 in both end portions. A handle 53a is provided in one end portion of the lower case 52, and a handle 53b is provided in the other end portion. The handle 53a and the handle 53b have the same shape, are identical in shape to the already described handle 53 of Embodiment 1, and will not be described in detail.

As illustrated in FIG. 6, the adhering portions 523 are formed on the outside surface 525a of the bottom plate 525 of the lower case 52. The adhering portions 523 are formed on both end portions of the outside surface 525a. The adhering portion 523 includes the adhering portion 523a provided in one end portion near the handle 53a and an adhering portion 523c provided in the other end portion near the handle 53b.

Both the adhering portion 523a and the adhering portion 523c have a substantially rectangular shape extending in the length direction of the outside surface 525a (electric connection box 100A). The length of the adhering portion 523a exceeds the length of the adhering portion 523c, and the adhering portion 523a and the adhering portion 523c have the same width.

The reduction portion 524a is formed in the adhering portion 523a. In the adhering portion 523a, the reduction portion 524a is formed in the short side portion that is one of both short sides in the length direction and close to the handle 53a. The reduction portion 524a is triangular with a vertex facing the handle 53a. A reduction portion 524c is formed in the adhering portion 523c. In the adhering portion 523c, the reduction portion 524c is formed in the short side portion that is one of both short sides in the length direction and close to the handle 53b. The reduction portion 524c is triangular with a vertex facing the handle 53b. In other words, the reduction portion 524a and the reduction portion 524c are reduced in area toward the handle 53a and the handle 53b and the reduced ends of the reduction portion 524a and the reduction portion 524c face the handle 53a and the handle 53b, respectively.

The other parts are similar to those of Embodiment 1, and detailed description thereof will be omitted with the same reference numerals given.

The electric connection box 100A of Embodiment 2 configured as described above can be easily and safely removed from the battery pack 500, which will be described in detail below.

In removing the electric connection box 100A of the present embodiment, a worker pulls the electric connection box 100A away from the battery pack 500 with the handle 53a or the handle 53b gripped.

First, a case where the worker grips the handle 53a and pulls the electric connection box 100A will be described.

As described above, the area of the reduction portion 524a is reduced toward the handle 53a, and thus the part that is closest to the handle 53a in the adhering portion 523a is smallest in area of contact with the battery pack 500 (cooling mechanism) in the adhering portion 523a and is easy to remove and it is easy to start removing the adhering portion 523a. Accordingly, the adhering portion 523a can be easily removed from the cooling mechanism of the battery pack 500.

Next, a case where the worker grips the handle 53b and pulls the electric connection box 100A will be described.

As described above, the area of the reduction portion 524c is reduced toward the handle 53b, and thus the part that is closest to the handle 53b in the adhering portion 523c is smallest in area of contact with the battery pack 500 (cooling mechanism) in the adhering portion 523c and is easy to remove and it is easy to start removing the adhering portion 523c. Accordingly, the adhering portion 523c can be easily removed from the cooling mechanism of the battery pack 500.

Accordingly, the electric connection box 100A of Embodiment 2 can be easily and safely removed from the battery pack 500 without deformation or damage.

The present disclosure is not limited to the above example in which a worker grips either the handle 53a or the handle 53b and pulls the electric connection box 100A in removing the electric connection box 100A of the present embodiment. As a matter of course, the present disclosure is also applicable when a worker grips both the handle 53a and the handle 53b and pulls the electric connection box 100A.

The embodiments disclosed this time are exemplifications in every respect and should be considered not restrictive. The scope of the present disclosure is defined not by the meaning described above but by the scope of the claims and is intended to include every modification within the meaning and scope equivalent to the scope of the claims.

It is to be noted that, as used herein and in the appended claims, the singular forms “a”, “an”, and “the” include plural referents unless the context clearly dictates otherwise.

It is to be noted that the disclosed embodiment is illustrative and not restrictive in all aspects. The scope of the present disclosure is defined by the appended claims rather than by the description preceding them, and all changes that fall within metes and bounds of the claims, or equivalence of such metes and bounds thereof are therefore intended to be embraced by the claims.

What is claimed is:

1. An electric connection box with a housing where an electronic component is mounted, wherein
an adhering portion adhering to an object is provided on an outside surface of the housing, and
the adhering portion has a reduction portion reduced in area toward at least one end portion of the housing.

2. The electric connection box according to claim 1, wherein
at least the one end portion of the housing is provided with a handle, and
a reduced end of the reduction portion is provided so as to face the handle.

3. The electric connection box according to claim 2, wherein
the housing includes a box-shaped member having the outside surface as a bottom surface and having an open surface facing the bottom surface, and
the handle is provided on the box-shaped member.

4. The electric connection box according to claim 3, wherein
the box-shaped member has a recess in a long-side middle portion, and
a side wall of the recess is provided with a plurality of ribs.

5. The electric connection box according to claim 3, wherein
the handle is provided on each of both end portions of the box-shaped member,
the adhering portion is provided on each of both end portions of the bottom surface, and
a reduced end of each adhering portion faces a nearest handle.
